(19) United States
(12) Patent Application Publication
(10) Pub. No.: US 2016/0245232 A1
(43) Pub. Date: Aug. 25, 2016

(54) Blocker Door Configuration for a Thrust Reverser of a Turbofan Engine

(71) Applicant: Rohr, Inc., Chula Vista, CA (US)

(72) Inventors: Thomas E. MacKay, San Diego, CA (US); Dan Jacobson, San Diego, CA (US); Michael Aten, San Diego, CA (US)

(21) Appl. No.: 14/626,889

(22) Filed: Feb. 19, 2015

(51) Int. Cl. F02K 1/76

(52) U.S. Cl. CPC F02K 1/766

(57) ABSTRACT

A thrust reverser for a turbofan engine having a bypass air flowpath is provided. The thrust reverser includes a plurality of blocker doors pivotally attached to a structure, and disposed circumferentially around a bypass air flow path, each blocker door having a forward edge, and aft edge, and two lateral edges joining the forward and aft edges, the two lateral edges and the forward and aft edges defining a perimeter of each blocker door. The thrust reverser is operable to be disposed in a stowed configuration wherein the plurality of blocker doors do not impede air flowing within the bypass air flowpath, and in a deployed configuration wherein the plurality of blocker doors reside in and substantially block the bypass air flowpath. In the stowed configuration the lateral edges of adjacent blocker doors are contiguous to one another.

### BACKGROUND OF THE INVENTION

1. Technical Field

The present disclosure relates to a thrust reverser for a turbofan engine and more particularly to thrust reverser blocker door configurations and operation.

2. Background Information

Turbofan engines are known to include a fan section that produces a bypass airflow for providing the majority of engine propulsion and a core airflow for compression, mixing with fuel, combustion and expansion through a turbine to drive the fan section. The engines further include nacelles that partially surround the core of the engine and provide an annular bypass airflow duct for directing the bypass airflow in a rearward direction to produce forward propulsion. A pylon secures the engine to a structure such as an aircraft wing. In some applications, the nacelle further includes a thrust reverser capable of redirecting the bypass airflow from the rearward direction (i.e. thrust for forward propulsion) to an alternative direction for producing rearward propulsion. Rearward propulsion produced by a thrust reverser can be used to decelerate the forward motion of an aircraft subsequent to touchdown of the aircraft during landing.

Thrust reversers may include a plurality of blocker doors with a stowed position for forward propulsion and a deployed position for rearward propulsion. In the stowed position, it is typical for at least a portion of the thrust reverser to define a portion of the flowpath for bypass airflow; e.g. during cruise operation a portion of the thrust reverser may form a portion of an outer radial boundary of the bypass flowpath. Because the bypass air encounters the portion of the thrust reverser during such operation, any detrimental flow characteristics within the bypass flowpath created by the thrust reverser are undesirable. Historically, some thrust reversers employed shaped blocker doors and bodies (sometimes referred to as “islands”) disposed between adjacent blocker doors in the stowed configuration to mitigate detrimental flow characteristics within the bypass flowpath. Although these type thrust reverser configurations may to some degree mitigate detrimental flow characteristics within the bypass flowpath while in the stowed configuration, they are not optimum. Hence, there exists a need to improve thrust reverser configuration.

### SUMMARY

According to an aspect of the present disclosure, a thrust reverser for a turbofan engine having a bypass air flowpath is provided. The engine has a rotational axis. The thrust reverser includes a first structure, a second structure, a plurality of blocker doors, and a plurality of individual linkages. The second structure is operable to be translated by an actuator relative to the first structure between a stowed position and a deployed position. The plurality of blocker doors are pivotally attached to the first structure, and are disposed circumferentially around the bypass air flow path. Each blocker door has a forward edge, and aft edge, and two lateral edges joining the forward and aft edges. The two lateral edges and the forward and aft edges define a perimeter of the blocker door. Each of the plurality of individual linkages connects a respective one of the plurality of blocker doors to the second structure. The thrust reverser is operable to be disposed in a stowed configuration wherein the plurality of blocker doors reside outside of the bypass air flowpath, and in a deployed configuration wherein the plurality of blocker doors reside in and substantially block the bypass air flowpath. In the stowed configuration the lateral edges of adjacent blocker doors are contiguous one another.

In a further embodiment of the foregoing aspect, in the deployed configuration, each blocker door at least partially overlaps with an adjacent blocker door.

In further embodiments of the foregoing aspect, the plurality of blocker doors includes a plurality of forward blocker doors and a plurality of aft blocker doors, and in the deployed configuration each lateral edge of each forward blocker door is forward of and at least partially overlaps the respective lateral edge of the adjacent aft blocker door.

In further embodiments of the foregoing aspect, each forward blocker door is attached to the first structure along a forward hinge line, which forward hinge line extends circumferentially at a first axial position, and each aft blocker door is pivotally attached to the first structure along an aft hinge line, which aft hinge line extends circumferentially at a second axial position, and wherein the forward hinge line is axially displaced from the aft hinge line by a distance.

In further embodiments of the foregoing aspect, each of the plurality of blocker doors has a first width extending along the forward edge of the blocker door, a second width extending along the aft edge of the blocker door, and the first and second widths substantially equal one another.

In further embodiments of the foregoing aspect, each of the plurality of blocker doors has a substantially rectangular shape.

In further embodiments of the foregoing aspect, each blocker door is pivotally attached proximate the forward edge to the second structure, and each blocker door is attached to pivot about a blocker door axis that is skewed by an angle from a plane normal to the axis of the engine.

In further embodiments of the foregoing aspect, the angle of each blocker door axis is in the range of about three to seven degrees from the plane normal to the axis of the engine.

In further embodiments of the foregoing aspect, the angles of the blocker door axes equal one another.

In further embodiments of the foregoing aspect, at least one of the blocker door axes is at a dissimilar angle relative to the angle of the remaining blocker door axes.

According to another aspect of the present disclosure, a thrust reverser for a turbofan engine having a bypass air flowpath is provided. The engine has a rotational axis. The thrust reverser includes a plurality of blocker doors pivotally attached to a structure, and disposed circumferentially around a bypass air flow path, each blocker door having a forward edge, and aft edge, and two lateral edges joining the forward and aft edges, the two lateral edges and the forward and aft edges defining a perimeter of each blocker door. The thrust reverser is operable to be disposed in a stowed configuration wherein the plurality of blocker doors do not impede air flowing within the bypass air flowpath, and in a deployed configuration wherein the plurality of blocker doors reside in and substantially block the bypass air flowpath. In the stowed configuration the lateral edges of adjacent blocker doors are contiguous to one another.

In a further embodiment of the foregoing aspect, in the deployed configuration, each blocker door at least partially overlaps with an adjacent blocker door.

In further embodiments of the foregoing aspect, the plurality of blocker doors includes a plurality of forward blocker doors and a plurality of aft blocker doors, and in the deployed configuration each lateral edge of each forward blocker door is forward of and at least partially overlaps the respective lateral edge of the adjacent aft blocker door.

In further embodiments of the foregoing aspect, each forward blocker door is attached to the structure along a forward hinge line, which forward hinge line extends circumferentially at a first axial position, and each aft blocker door is pivotally attached to the structure along an aft hinge line, which aft hinge line extends circumferentially at a second axial position, and wherein the forward hinge line is axially displaced from the aft hinge line by a distance.

In further embodiments of the foregoing aspect, each blocker door is pivotally attached proximate the forward edge to the structure, and each blocker door is attached to pivot about a blocker door axis that is skewed by an angle from a plane normal to the axis of the engine.

The foregoing features and elements may be combined in various combinations without exclusivity, unless expressly indicated otherwise. These features and elements as well as the operation thereof will become more apparent in-light of the following description and the accompanying drawings. It should be understood, however, the following description and figures are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a perspective view of a turbofan engine.

FIG. 2 is an exploded view of the turbofan engine.

FIG. 3 is a partial cross sectional view of an embodiment of the present thrust reverser shown in a stowed configuration.

FIG. 4 is a partial cross-sectional view of the embodiment of the present thrust reverser shown in FIG. 3, shown in a deployed configuration.

FIG. 5 is a diagrammatic view of a forward blocker door embodiment.

FIG. 6A is a diagrammatic sectional, side view of a thrust reverser, illustrating blocker doors in a stowed configuration.

FIG. 6B is a diagrammatic sectional, side view of a thrust reverser, illustrating blocker doors in a translational position between a stowed configuration and a deployed configuration.

FIG. 6C is a diagrammatic sectional, side view of a thrust reverser, illustrating blocker doors in a deployed configuration.

FIG. 7 is a diagrammatic planar view of present disclosure blocker doors shown in a stowed configuration.

FIG. 8 is a diagrammatic perspective view of prior art blocker doors and islands shown in a stowed configuration.

FIG. 9 is a top planar diagrammatic view of an embodiment of the present thrust reverser shown in a stowed configuration.

FIG. 10 is an axial perspective diagrammatic view of an embodiment of the present thrust reverser shown in a deployed configuration.

FIG. 11 is a partial cross-sectional top view of an embodiment of the present thrust reverser shown in a deployed configuration, illustrating blocker doors disposed on skewed pivot axes.

FIG. 12 is a partial cross-sectional top view of a thrust reverser shown in a deployed configuration, illustrating blocker doors disposed on pivot axes perpendicular to the engine rotational axis.

FIG. 13 is a partial cross-sectional axial view of an embodiment of the present thrust reverser shown in a stowed configuration.

FIGS. 14-16 are partial cross-sectional axial views of the embodiment of the present thrust reverser shown in FIG. 13 in translated positions, progressively toward a deployed configuration.

FIG. 17 is a partial cross-sectional axial view of the embodiment of the present thrust reverser shown in FIG. 13, shown in a deployed configuration.

### DETAILED DESCRIPTION

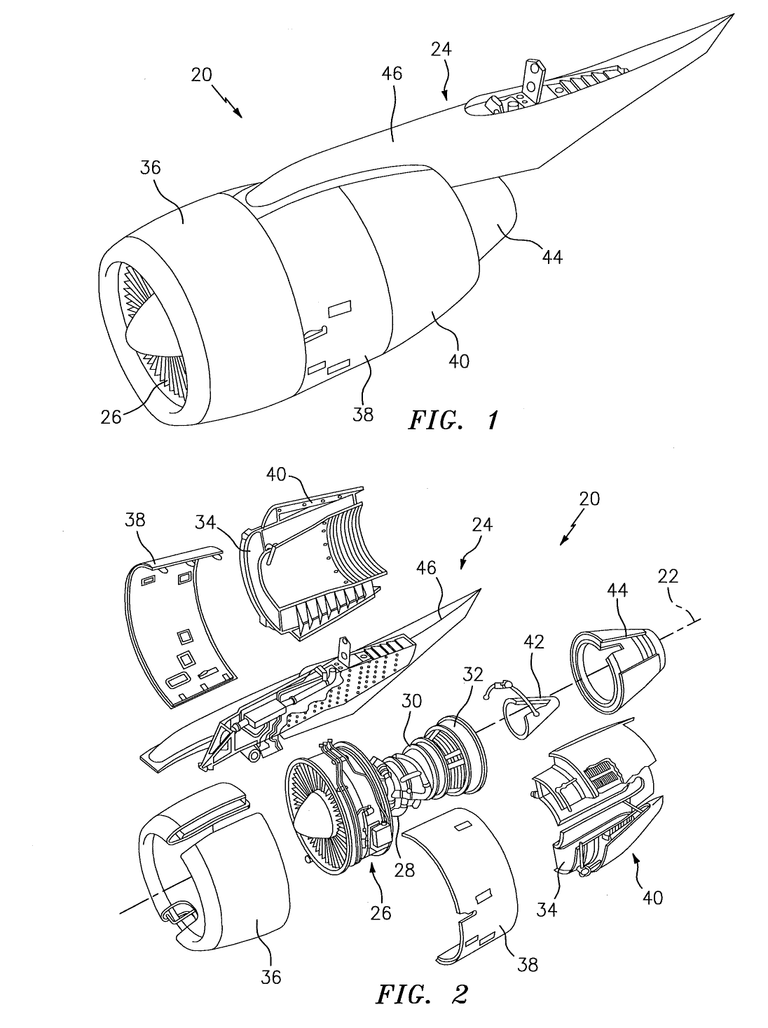

Referring to FIGS. 1 and 2, a turbofan engine 20 is centered about an axis 22 and includes a nacelle 24 that supports and generally surrounds an inner engine core that includes a fan section 26, a compressor section 28, a combustor section 30 and a turbine section 32. The fan section 26 drives air along a bypass flowpath 34. A portion of air from the fan section 26 enters the engine core flowpath (not shown) for compression by the compressor section 28, then into the combustor section 30. The core air is mixed with fuel in the combustor section 30 and burned producing energy. The core air or exhaust from the combustor section 30 is expanded through the turbine section 32 and, in-turn, drives a central shaft (not shown) that powers the fan section 26.

The combusted core airflow generally powers the fan section 26 and the bypass airflow provides the majority of forward propulsion for the engine 20. More traditional turbofan engines may have a bypass airflow to core airflow ratio (i.e. bypass ratio) of about six (6:1). More recent high-bypass ratio engines, such as a geared turbofan engine may have greater bypass ratios and that may exceed ten (10:1). The present disclosure thrust reverser 40 is not limited to use with any particular type of turbofan engine.

The nacelle 24 may include an intake cowl 36 disposed forward of the fan section 26, a fan cowl 38 that circumferentially surrounds and shields the fan section 26, a thrust reverser 40 that may circumferentially surround the compressor, combustor and turbine sections 28, 30, 32, an exhaust centerbody 42 aft of the turbine section 32, an exhaust nozzle 44 that is spaced radially outward from the exhaust centerbody 42, and a pylon 46 that supports the engine 20 typically to an undercarriage of an aircraft wing (not shown).

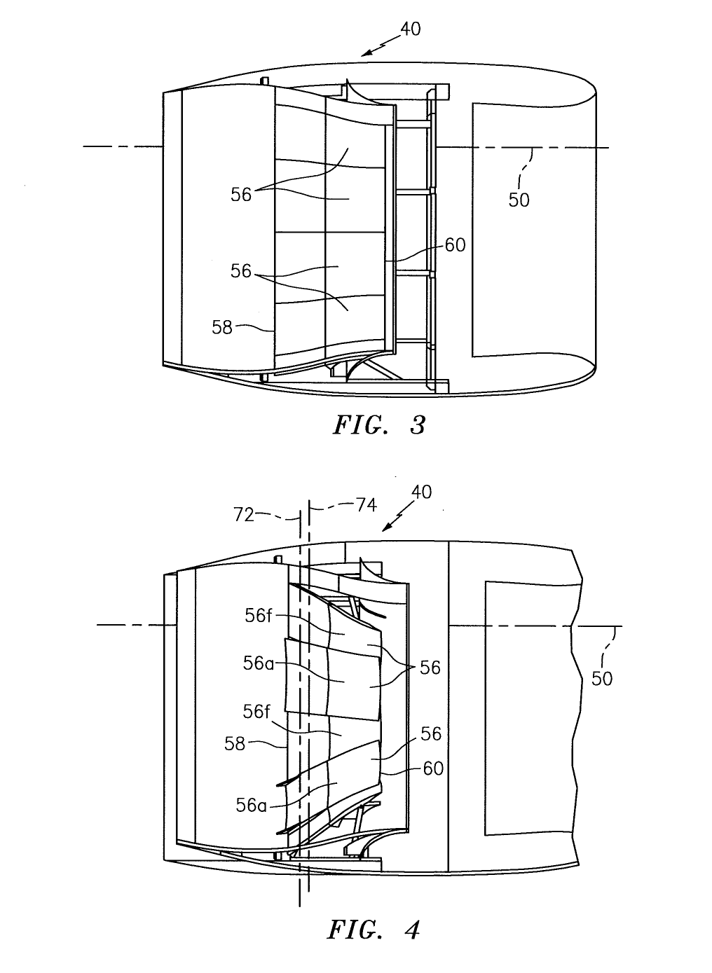

Referring to FIGS. 3 and 4, the thrust reverser 40 is operable to be disposed in a deployed configuration and in a stowed configuration (and translated movement there between). In the stowed configuration (see FIG. 3), the thrust reverser 40 is disposed to not substantially impede bypass airflow traveling within the bypass flowpath 50, which bypass airflow is therefore available for producing thrust useful for forward propulsion of the aircraft. In the deployed configuration (see FIG. 4), the thrust reverser 40 is disposed to substantially block the bypass flowpath 50 associated with forward propulsion, causing the bypass airflow traveling within the bypass flowpath 50 to divert to a reverse thrust flowpath that counters forward propulsion of the aircraft. The reverse flow path 52 extends through cascades 54 having vanes which turn the air in the forward direction. The cascades 54 are exposed and the reverse flow path 52 is opened when a portion of the thrust reverser 40 translates aftward. The bypass flowpath 50 may be described as being radially disposed between an inner shell and an outer shell. The bypass flowpath 50 may be generally annular in shape, and the thrust reverser 40 may be located relative to a portion of the bypass flowpath 50 immediately downstream of the fan section.

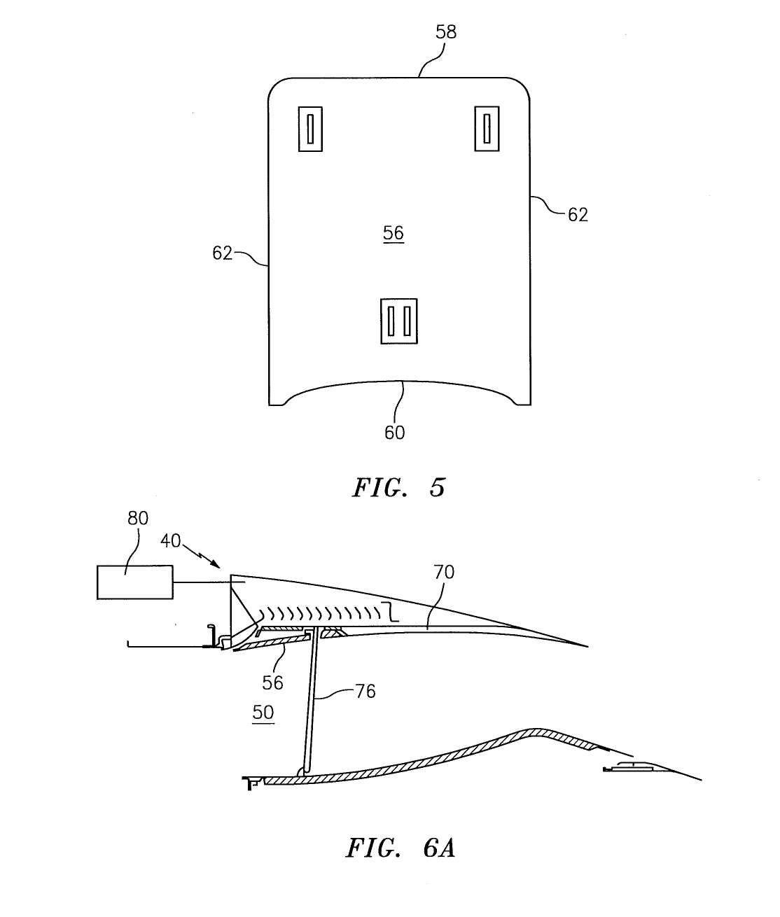

Now referring to FIG. 5, a first embodiment of the present thrust reverser 40 includes a plurality of blocker doors 56, including forward blocker doors 56f and a plurality of aft blocker doors 56a (see FIG. 4). To simplify the description herein, hereinafter the forward blocker doors 56f and aft blocker doors 56a are described as having the same configuration. In alternative embodiments, the forward and aft blocker doors 56f, 56a may have different configurations. Each blocker door 56 may be described as having a body that extends lengthwise between a forward edge 58 and an aft edge 60, and widthwise between lateral edges 62. Each blocker door 56 has a thickness that extends between a flowpath surface 66 and a back surface 68. The blocker door 56 has a width extending along the forward edge 58 of the blocker door 56, and a width extending along the aft edge 60 of the blocker door 56. In some embodiments, the width of the blocker door 56 along the forward edge 58 and the width of the blocker door 56 along the aft edge 60 are substantially equal one another. In such embodiments, the blocker door 56 may be described as having a substantially rectangular shape. As will be explained below, each blocker door 56 is positionally oriented within the thrust reverser 40 so that the flowpath surface 66 faces the bypass flowpath 50, and the back surface faces away from the bypass flowpath 50.

Each blocker door 56 is pivotally attached proximate its forward edge 58 (e.g. by hinges), to an axial translating element 70 of the thrust reverser 40. The term “axial” is used herein to describe that the aforesaid translating element 70 moves axially, but the aforesaid translating element 70 is not limited to sole axial translation in all contemplated embodiments. Each forward blocker door 56f is pivotally attached at points circumferentially disposed along a first axial position (the axial position of the pivot points of the forward blocker doors 56f is hereinafter referred to as a “forward hinge line 72”). Each aft blocker door 56a is pivotally attached to a stationary element at pivot points circumferentially disposed at a second axial position (the axial position of the aft blocker door 56a pivot points is hereinafter referred to as an “aft hinge line 74”). The aft hinge line 74 may be axially displaced aft of the forward hinge line 72 a small distance. As indicated below, the displacement between the forward and aft hinge axes 72, 74 are shown diagrammatically with phantom lines in FIG. 4. The forward and aft blocker doors 56f, 56a are alternately disposed around the circumference of the bypass flowpath 50; i.e. each forward blocker door 56f is disposed at a position circumferentially between two aft blocker doors 56a (except for blocker doors at the end of the annular array of blocker doors).

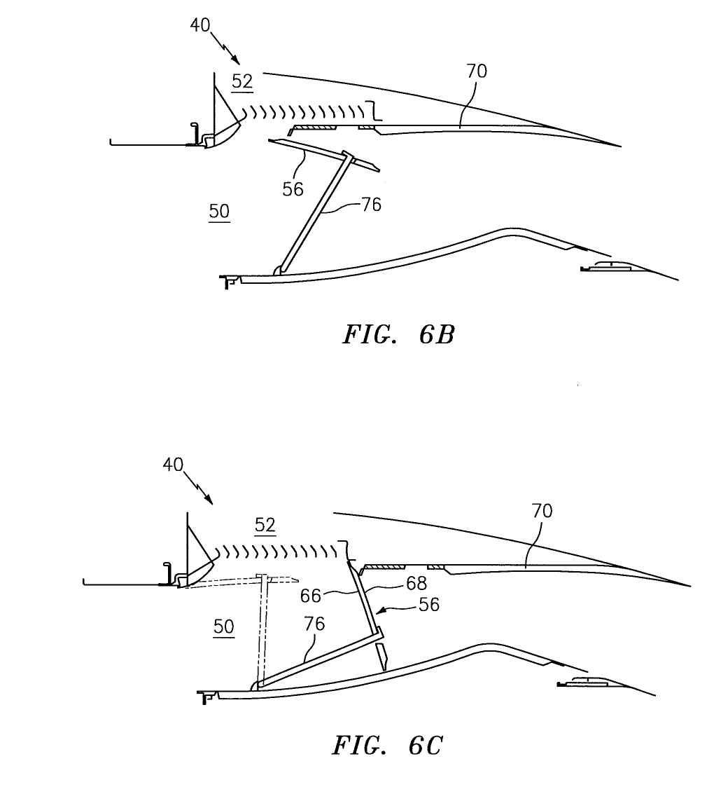

Now referring to FIGS. 6A-6C, each forward and aft blocker door 56f, 56a may be actuated in accordance with known actuation systems using kinematic linkages or other systems. For example, each forward and aft blocker door 56f, 56a may be pivotally attached to a drag link 76, typically near the aft edge 60 of the blocker door 56f, 56a. Each drag link 76 is pivotally attached at one end thereof to the blocker door 56f, 56a, and at an opposite end thereof to an inner fixed structure 78 of the thrust reverser 40. As the translating element 70 moves aftward during thrust reverser 40 deployment, the blocker doors 56f, 56a also move aftward. As the blocker door moves aftward, the drag link 76 pivots and the end of the drag link 76 pivotally attached to the inner fixed structure 78 begins to pull the aft end of the blocker door 56f, 56a radially inward toward the engine.

The axial translating element 70 is axially positionable between: a) a thrust reverser 40 stowed position, wherein the linkages maintain the blocker doors in the stowed configuration (see FIG. 6A); and b) a thrust reverser 40 deployed position (see FIG. 6C), wherein the linkages maintain the blocker doors in the deployed configuration. Axial translation of the axial translating element 70 therefore causes the linkages to move the blocker doors into the stowed configuration, or the deployed configuration, and translation there between.

The thrust reverser 40 includes at least one actuator 80 (diagrammatically shown in FIG. 6A) to accomplish the axial movement of the axial translating element 70. The actuator 80 may be hydraulically, pneumatically, or electrically powered, or some combination thereof. The actuator80 may have a drive unit secured rigidly to a stationary structure of the thrust reverser 40 and an arm linked to the axial translating element 70 and capable of being extended and retracted from the drive unit. The actuation of the linkages occurs with the driven axial translation of the axial translating element 70, which in turn is accomplished using the actuator.

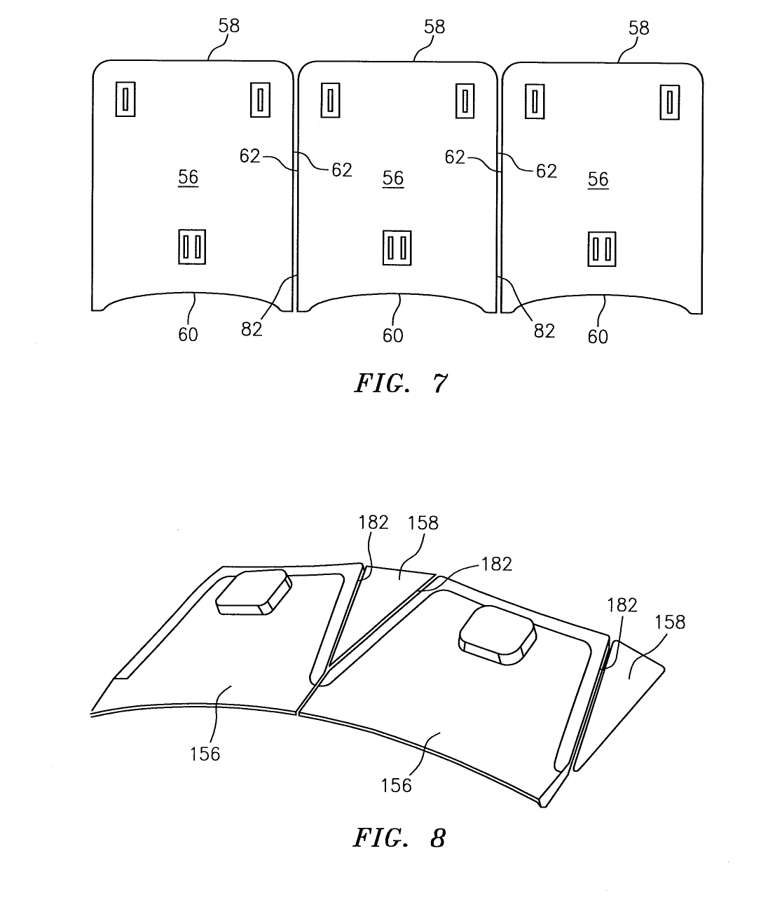

In the stowed configuration (see FIGS. 3 and 6A), the lateral edges 62 of adjacent blocker doors (i.e. a forward blocker door 56f and an adjacent aft blocker door 56a) are disposed substantially contiguous with one another (e.g., see FIG. 7). As used herein, the term “contiguous” is defined as meaning “in close physical proximity”. Hence, adjacent blocker doors 56f, 56a having lateral edges 62 that are disposed substantially contiguous with one another are blocker doors having respective lateral edges 62 that are substantially parallel one another with little gap (no more than thirteen millimeters (13 mm), and more typically less than four millimeters (4 mm)) or no gap between the respective lateral edges 62. As a result, in the stowed configuration there exists a single split line 82 between each pair of adjacent blocker doors. In prior art thrust reversers of which we are aware (e.g., see FIG. 8), the blocker doors 156 have at least in part a trapezoidal shape and each pair of adjacent blocker doors 156 is separated by an island 158 (independent of the adjacent blocker doors 156) when the prior art doors are in the stowed configuration. As a result in such a prior art configuration, there are two split lines 182, one between each blocker door 156 and the respective side surface of the island. In contrast, within the present disclosure with contiguous blocker door lateral edges 62, the number of split lines 82 is reduced by half. In addition, with the present blocker doors in the stowed configuration, the split lines 82 are also substantially aligned with the direction of flow or air inside the bypass flow path. In contrast, the split lines 182 within prior art blocker door/island configurations are disposed at an angle relative to the direction of airflow inside the bypass flow path.

In the deployed configuration of the present disclosure (see FIG. 4), a portion of adjacent blocker doors along the respective lateral edges 62 (i.e. a forward blocker door 56f and an adjacent aft blocker door 56a) must overlap with one another. For example, as can be seen in FIG.4, portions of each aft blocker door 56a are disposed axially behind the adjacent forward blocker doors 56f; i.e. portions of the flowpath surface 66 of each at blocker door 56a faces a portion of the back surface of each adjacent forward blocker door 56f. This is because the width of the forward edge 58 of each blocker door is approximately the same dimension as the width of the aft edge 60. This overlap must be accommodated so that adjacent blocker doors do not clash or interfere with one another. One way to achieve this result is to arrange the hinge axes of the forward blocker doors 56f slightly axially forward of the aft blocker doors 56a (shown diagrammatically with phantom lines in FIG. 4). In the deployed configuration, the collective aft and forward blocker doors form a substantially continuous bypass flowpath annular blocking plane.

During normal flight conditions, the thrust reverser 40 is disposed in the stowed configuration (e.g. see FIGS. 3 and 6A). In the thrust reverser 40 stowed configuration, the axial translating element 70 is disposed in the stowed position and the blocker doors are generally parallel with the bypass flowpath 50. The actuator 80 may be used to maintain the axial translating element 70 in the stowed position.

During certain flight scenarios (e.g. landing), deployment of the thrust reverser 40 may be initiated. FIGS. 3, 4, and 6A-6C provide diagrammatic views of an embodiment of the present thrust actuator from a side perspective of the thrust reverser 40. FIGS. 3 and 6A depict the thrust reverser 40 in the stowed configuration and FIGS. 4 and 6C depict the thrust reverser 40 in the deployed configuration. FIG. 6B depicts the thrust reverser 40 at a translation position between the slowed and deployed configurations.

The actuator 80 is controlled to axially translate the axial translating element 70; e.g. in an axially rearward direction. As the axial translating element 70 is translated, a clearance opening is created within the outer radial surfaces of the bypass flowpath 50. As the clearance opening increases in size, a cascade array 54 or at least one turning vane (disposed radially outside of the bypass flowpath 50) is increasingly revealed and functions to further turn the bypass flow of air in at least a partially forward direction.

As the axial translating element 70 moves axially, each of the blocker doors 56f, 56a begins to pivot about its' pivotal connection with the translating element 70. The pivoting of the blocker doors is caused by axial translation of the translating element 70 and the linkage connecting the respective blocker door to the inner fixed structure 78. As each blocker door deploys, it transitions between the stowed configuration and the deployed configuration.

Once the blocker doors 56f, 56a are positioned in the deployed configuration, the bypass flowpath 50 is substantially blocked and the bypass airflow is diverted through the cascade array 54 and into the reverse thrust flowpath. When in the fully deployed state, the aft edge 60 of each blocker door 56f, 56a may be proximate to the inner fixed structure 78, thereby substantially blocking the bypass flowpath 50.

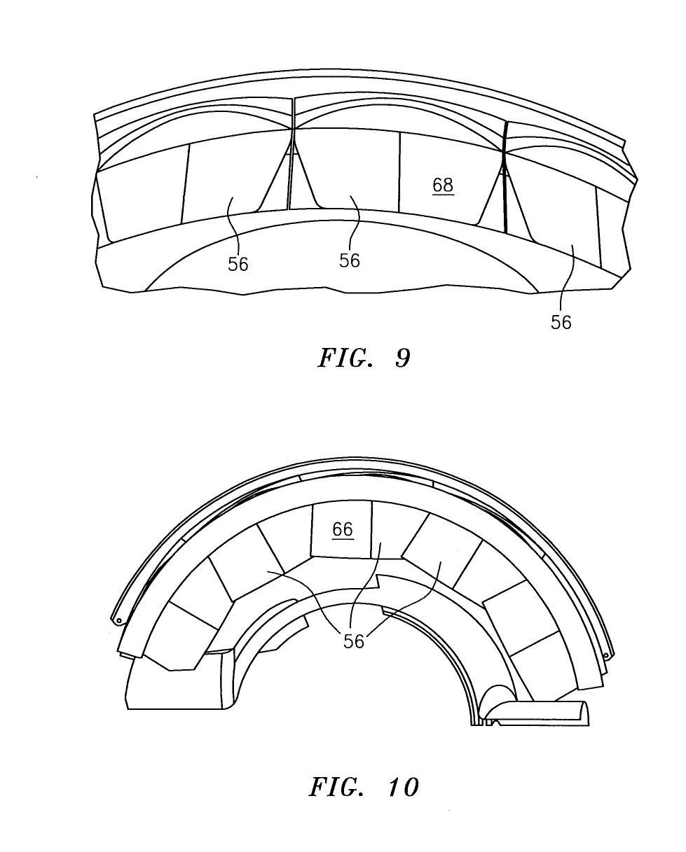

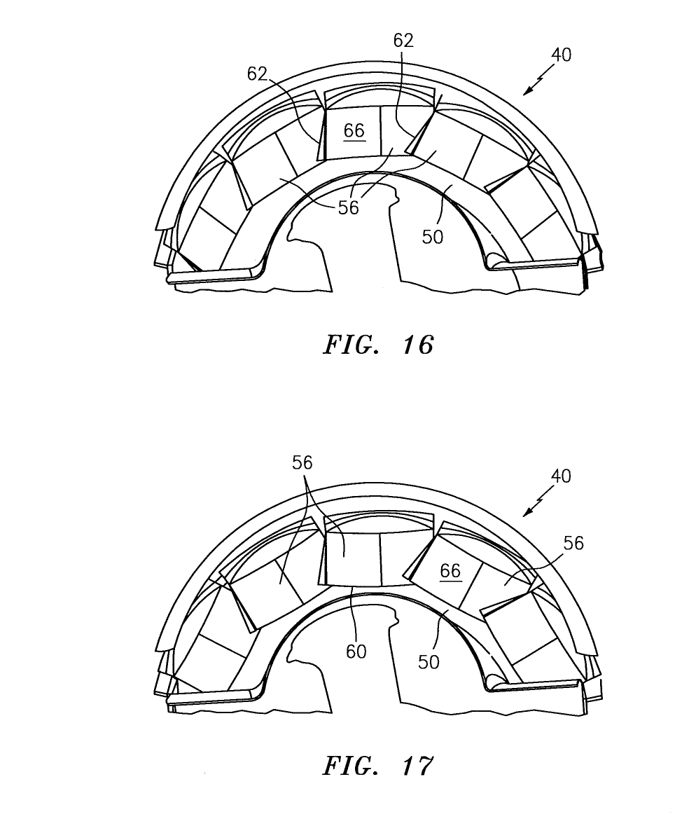

Now referring to FIGS. 9-17, in a second embodiment of the present thrust reverser 40 the thrust reverser 40 includes a plurality of blocker doors 56. Each blocker door 56 may be described as having a body that extends lengthwise between a forward edge 58 and an aft edge 60, and widthwise between lateral edges 62 (e.g. see FIG. 5). Each blocker door 56 has a thickness that extends between a flowpath surface 66 and a back surface 68. As will be explained below, each blocker door 56 is positionally oriented within the thrust reverser 40 so that the flowpath surface 66 faces the bypass flowpath 50, and the back surface 68 faces away from the bypass flowpath 50.

In the stowed configuration of the embodiment shown in FIG. 9, the lateral edges 62 of adjacent blocker doors 56 align are contiguous with one another, in a manner that minimizes the split lines 82 between the blocker doors 56 as previously discussed with respect to the first embodiment. Minimizing the split lines 82 contributes to minimizing aerodynamic drag within the bypass flow path. When the thrust reverser 40 is in the deployed configuration as can be seen in FIG. 10, a portion of each blocker door 56 may overlap with an adjacent blocker door 56 along a lateral edge to mitigate bypass airflow leakage between the adjacent blocker doors 56.

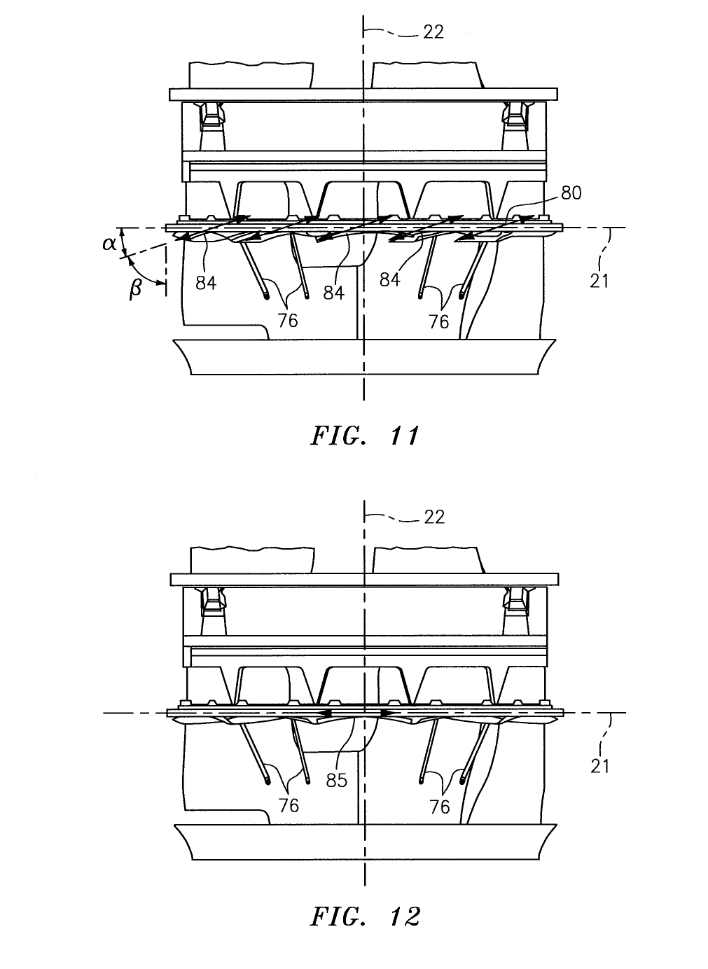

Each blocker door 56 is pivotally attached proximate its' forward edge 58 (e.g. by hinges), to an axial translating element 70 of the thrust reverser 40 which moves between a forward stowed position and an aft deployed position corresponding with the thrust reverser's stowed and deployed positions. Each blocker door 56 is attached to pivot about an axis (“blocker door pivot axis 84”) that is skewed by an angle “α” from a plane normal to the axis 22 of the engine. The individual blocker door pivot axes 84 do not lie in a common plane, but they each remain at approximately the same station of the thrust reverser 40. The skew angle “α” may be in the range of about three to seven degrees (3-7°), and is preferably about five degrees (5°) from the aforesaid line perpendicular to axis 22 of the engine. In some embodiments, the skew angles of all the blocker door axes 84 equal one another. In alternative embodiments, one or more blocker door axes may be disposed at a dissimilar angle relative to the angle of the remaining blocker door axes. FIG. 11 illustrates the skew angle “α” exaggerated slightly more than five degrees to make it easier to recognize the skew angle. The skew angle of the blocker door pivot axis may alternatively be described as being skewed from the axis 22 of the engine by an angle “β”, which angle “β” is less than ninety degrees (90°); The blocker door pivot axis skew angle “β” is preferably about eighty-five degrees (85°). To further illustrate the skewed angle of the blocker door pivot axis, FIG. 12 illustrates a thrust reverser 40 having blocker doors 56 that rotate about a pivot axis 85 that extends along a line perpendicular to axis 22 of the engine; i.e. the blocker doors 56 in FIG. 12 rotate in a plane that is aligned with the axis 22 of the engine.

As previously described, each blocker door 56 is actuated by a mechanical linkage or other actuation system, which may comprise an elongated drag link 76 pivotally connected at one end thereof to the blocker door 56 (usually near the aft edge) and at the opposite end to the inner fixed structure 78 (e.g., see FIGS. 6A-6C). As the axial translating element 70 translates aftward, the blocker doors 56 translate aftward with it and at the same time the drag links 76 rotate and pull the aft end of the blocker doors 56 radially inward to block the bypass flow path. In this embodiment, because the blacker door pivot axis 84 is not in a plane normal to the engine axis or more importantly in a plane normal to the pivoting motion of the drag links 76, the angle of the drag link 76 relative to the blocker door 56 will change during deployment. Thus, the drag link 76 may need to be pivotally attached to the blocker door 56 with a spherical or other similar bearing to into account this extra relative motion.

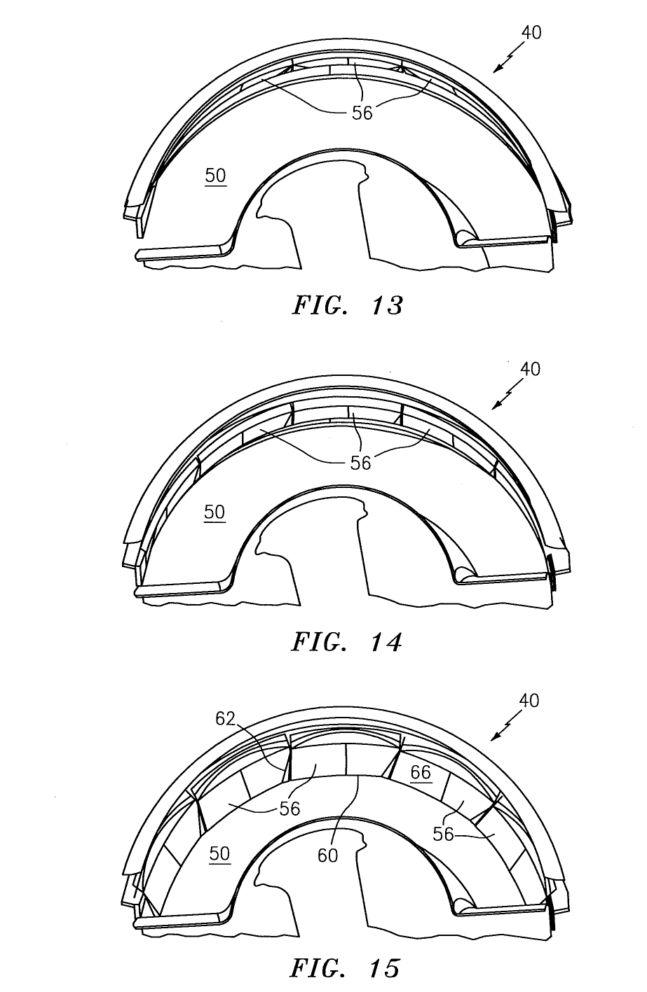

The axial translating element 70 is axially positionable between: a) a thrust reverser 40 stowed position (e.g., see FIGS. 9 and 13), wherein the linkages maintain the blocker doors 56 in the stowed configuration; and b) a thrust reverser 40 deployed position (e.g., see FIGS. 10 and 17), wherein the linkages maintain the blocker doors 56 in the deployed configuration. Axial translation of the axial translating element 70 therefore causes the linkages to move the blocker doors 56 into the stowed configuration, or the deployed configuration, and translation there between.

The thrust reverser 40 includes at least one actuator (not shown) to accomplish the axial movement of the axial translating element 70, as previously described with respect to the first embodiment.

In the stowed configuration (e.g. see FIGS. 9 and 13), the lateral edges 62 of adjacent blocker doors 56 are contiguous and spaced closely together with a single split line 82 between them. As a result in the stowed configuration, the collective blocker doors 56 form a substantially continuous bypass flowpath surface 66. This is in contrast to prior art blocker door arrangements having an “island” disposed between the lateral edges 62 of adjacent blocker doors in a stowed configuration to create a substantially continuous bypass flowpath surface 66 (e.g., see FIG. 8).

In the deployed configuration (e.g., see FIGS. 10 and 17), a portion of the lateral edges 62 of adjacent blocker doors 56 must overlap with one another, because the forward edges 58 and aft edges 60 of each blocker door 56 are approximately the same dimension. For example as can be seen in FIG. 10, a portion of each blocker door 56 is disposed axially behind an adjacent blocker door 56; i.e. portions of the flowpath surface 66 of a first blocker door 56 faces a portion of the back surface of an adjacent blocker door 56. In this embodiment, this relationship of adjacent blocker doors 56 is achieved without a clash as a result of the blocker door pivot axis being outside of a plane that is normal to the engine axis, and the individual blocker door pivot axes 84 not lying in the same plane. In the deployed configuration, the collective blocker doors 56 form a substantially continuous bypass flow path annular blocking surface.

During normal flight conditions, the thrust reverser 40 is disposed in the stowed configuration in the thrust reverser 40 stowed configuration, the axial translating element 70 is disposed in the stowed position and the blocker doors 56 define a portion of the bypass flowpath 50.

During certain flight scenarios (e.g. landing), deployment of the thrust reverser 40 may be initiated. FIGS. 13-17 provide a diagrammatic view of an embodiment of the present thrust actuator from an axial perspective taken from the forward end (i.e. the fan side) of the thrust reverser 40. FIG. 13 depicts the thrust reverser 40 in the stowed configuration. FIG. 17 depicts the thrust reverser 40 in the deployed configuration. FIGS. 14-16 depict the thrust reverser 40 in progressively further translated positions.

The actuator is controlled to axially translate the axial translating element 70; e.g. in an axially rearward direction. As the axial translating element 70 is translated, a clearance opening is created within the outer radial surfaces of the bypass flowpath 50. As the clearance opening increases in size, a cascade array 54 or at least one turning vane (disposed radially outside of the bypass flowpath 50) may be increasingly revealed and functions to further turn the bypass flow of air in at least a partially forward direction.

As the axial translating element 70 moves axially, each of the blocker doors 56 begins to pivot radially inward toward the engine and into the bypass duct about its' blocker door pivot axis. The pivoting of the blocker doors 56 is caused by axial translation of the axial translating element 70 and the linkage connecting the respective blocker door 56 to the inner fixed structure 78. As each blocker door 56 deploys, it transitions between its stowed configuration and its deployed configuration.

Once the blocker doors 56 are positioned in the deployed configuration, the bypass flowpath 50 is substantially blocked and the bypass airflow is diverted through the cascade array 54 and into the reverse thrust flowpath.

In both embodiments described above, it may be necessary to control the order in which adjacent blocker doors 56 open. Because the adjacent lateral edges 62 of each door are contiguous and closely spaced, if both doors 56 open at the same time and same rate, then the aft end of each lateral edge will move together and may interfere with one another. This can be avoided in a number of different ways. In one exemplary solution, a lost motion device is incorporated between the drag link 76 and the door, and is tuned to result in more lost motion in every other blocker door 56. This results in every other blocker door 56 delaying the beginning of its pivoting motion relative to the translating element 70 when the translating element 70 begins to move aft. This delay allows time for the blocker doors 56 positioned between those provided with this lost motion to begin their pivotal motion and deployment. The incorporation of the lost motion can be accomplished in several known manners similar to lost motion that is incorporated into blocker doors 56 currently for the purpose of providing a radial outward bias to the blocker door 56 in the stowed position.

It is understood that relative positional terms such as “forward,” “aft,” “upper,” “lower,” “above,” “below,” and the like are with reference to the normal operational attitude and should not be considered otherwise limiting. It is also understood that like reference numerals identity corresponding or similar elements throughout the several drawings. It should be understood that although a particular component arrangement is disclosed in the illustrated embodiment, other arrangements will also benefit. Although particular step sequences may be shown, described, and claimed, it is understood that steps may be performed in any order, separated or combined unless otherwise indicated and will still benefit from the present disclosure.

The foregoing description is exemplary rather than defined by the limitations described. Various non-limiting embodiments are disclosed; however, one of ordinary skill in the art would recognize that various modifications and variations in light of the above teachings will fall within the scope of the appended claims. It is therefore understood that within the scope of the appended claims, the disclosure may be practiced other than as specifically described. For this reason, the appended claims should be studied to determine true scope and content.

We claim:

1. A thrust reverser for a turbofan engine having a bypass air flowpath, which engine has a rotational axis, the thrust reverser comprising:
a first structure;
a second structure;
wherein the second structure is operable to be translated by an actuator relative to the first structure between a stowed position and a deployed position; and
a plurality of blocker doors pivotally attached to the first structure, and are disposed circumferentially around the bypass air flow path, each blocker door having a forward edge, and aft edge, and two lateral edges joining the forward and aft edges, the two lateral edges and the forward and aft edges defining a perimeter of the blocker door; and
a plurality of individual linkages, each linkage connecting a respective one of the plurality of blocker doors to the second structure;
wherein the thrust reverser is operable to be disposed in a stowed configuration wherein the plurality of blocker doors reside outside of the bypass air flowpath, and in a deployed configuration wherein the plurality of blocker doors reside in and substantially block, the bypass air flowpath; and
wherein in the stowed configuration the lateral edges of adjacent blocker doors are contiguous one another.

2. The thrust reverser of claim 1, wherein in the deployed configuration, each blocker door at least partially overlaps with an adjacent blocker door.

3. The thrust reverser of claim 2, wherein the plurality of blocker doors includes a plurality of forward blocker doors and a plurality of aft blocker doors, and in the deployed configuration each lateral edge of each forward blocker door is forward of and at least partially overlaps the respective lateral edge of the adjacent aft blocker door.

4. The thrust reverser of claim 3, wherein each forward blocker door is attached to the first structure along a forward hinge line, which forward hinge line extends circumferentially at a first axial position, and each aft blocker door is pivotally attached to the first structure along an aft hinge line, which aft hinge line extends circumferentially at a second axial position, and wherein the forward hinge line is axially displaced from the aft hinge line by a distance.

5. The thrust reverser of claim 4, wherein each of the plurality of blocker doors has a first width extending along the forward edge of the blocker door, a second width extending along the aft edge of the blocker door, and the first and second widths substantially equal one another.

6. The thrust reverser of claim 4, wherein each of the plurality of blocker doors has a substantially rectangular shape.

7. The thrust reverser of claim 1, wherein each blocker door is pivotally attached proximate the forward edge to the second structure, and each blocker door is attached to pivot about a blocker door axis that is skewed by an angle from a plane normal to the axis of the engine.

8. The thrust reverser of claim 7, wherein the angle of each blocker door axis is in the range of about three to seven degrees from the plane normal to the axis of the engine.

9. The thrust reverser of claim 7, wherein the angles of the blocker door axes equal one another.

10. The thrust reverser of claim 7, wherein at least one of the blocker door axes is at a dissimilar angle relative to the angle of the remaining blocker door axes.

11. A thrust reverser for a turbofan engine having a bypass air flowpath, which engine has a rotational axis, the thrust reverser comprising:
a plurality of blocker doors pivotally attached to a structure, and disposed circumferentially around a bypass air flow path, each blocker door having a forward edge, and aft edge, and two lateral edges joining the forward and aft edges, the two lateral edges and the forward and of edges defining a perimeter of each blocker door; and
wherein the thrust reverser is operable to be disposed in a stowed configuration wherein the plurality of blocker doors do not impede air flowing within the bypass air flowpath, and in a deployed configuration wherein the plurality of blocker doors reside in and substantially block the bypass air flowpath; and
wherein in the stowed configuration the lateral edges of adjacent blocker doors are contiguous to one another.

12. The thrust reverser of claim 11, wherein in the deployed configuration, each blocker door at least partially overlaps with an adjacent blocker door.

13. The thrust reverser of claim 12, wherein the plurality of blocker doors includes a plurality of forward blocker doors and a plurality of aft blocker doors, and in the deployed configuration each lateral edge of each forward blocker door is forward of and at least partially overlaps the respective lateral edge of the adjacent aft blocker door.

14. The thrust reverser of claim 13, wherein each forward blocker door is attached to the structure along a forward hinge line, which forward hinge line extends circumferentially at a first axial position, and each aft blocker door is pivotally attached to the structure along an aft hinge line, which aft hinge line extends circumferentially at a second axial position, and wherein the forward hinge line is axially displaced from the aft hinge line by a distance.

15. The thrust reverser of claim 11, wherein each blocker door is pivotally attached proximate the forward edge to the structure, and each blocker door is attached to pivot about a blocker door axis that is skewed by an angle from a plane normal to the axis of the engine.
